(19) United States
(12) Patent Application Publication
(10) Pub. No.: US 2022/0065652 A1
(43) Pub. Date: Mar. 3, 2022

(54) Systems And Methods For Increasing Solar Power Generation During Vehicle Parking

(71) Applicant: Ford Global Technologies, LLC, Dearborn, MI (US)

(72) Inventor: David Michael Herman, Oak Park, MI (US)

(73) Assignee: Ford Global Technologies, LLC, Dearborn, MI (US)

(21) Appl. No.: 17/003,756

(22) Filed: Aug. 26, 2020

(51) Int. Cl. G01C 21/36; G01C 21/34; B60W 30/06; B62D 15/02

(52) U.S. Cl. CPC G01C 21/3685; G01C 21/3469; B62D 15/0285; B60W 30/06; G01C 21/3484

(57) ABSTRACT

Systems, methods, and computer-readable media are disclosed for increasing solar power generation during vehicle parking. Example methods may include determining that a first parking spot and a second parking spot are available within a line of sight via a vehicle sensor, determining a parking duration based on a user profile and a current location of the vehicle, determining a first shading area for the first parking spot and a second shading area the second areas based on the parking duration, determining, based on the first shading area and the second shading area, potential power generation at the first parking spot and the second parking spot during the parking duration, and determining, based on the potential power generation at the first parking spot and the second parking spot during the parking duration, which parking spot to park.

### FIELD

The present disclosure relates to systems and methods for vehicle parking, and more specifically, to methods and systems for increasing solar power generation during vehicle parking.

### BACKGROUND

Solar cells and solar system components have decreased in price substantially. At the same time, vehicles are increasingly becoming electrified through use of hybrid and electrical power systems. Furthermore, vehicle features such as connectivity and other systems require power usage even when a vehicle is parked. As a result, the use of solar power generation on the vehicle roof is increasing. Solar power generation may be reduced substantially due to effects of solar panel orientation towards the sun (e.g., mis-orientation), limited surface area available, the effects of shading on a solar panel, etc. For example, the shading on the solar panel may be caused by a street sign or due to another vehicle partially obscuring the sun from part of the solar panel or solar array at present or in the future. This will drive some solar cells into reverse bias which consumes energy rather than producing energy, increasing the solar cell's temperature and potentially risking a thermal runaway event. Typically, solar panels may incorporate a bypass diode into their electrical circuits to avoid risk of thermal runaway but at the cost of significant decrease in power production. Accordingly, a vehicle parking location may play an important role for charging a vehicle solar panel.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a diagram of an example implementation for increasing solar power generation during vehicle parking, in accordance with example embodiments of the disclosure.

FIG. 2 depicts an example process flow for increasing solar power generation during vehicle parking in accordance with one or more embodiments of the disclosure.

FIG. 3 depicts an example process flow for increasing solar power generation during vehicle parking in accordance with one or more embodiments of the disclosure.

FIG. 4 depicts an example process flow for increasing solar power generation during vehicle parking in accordance with one or more embodiments of the disclosure.

FIG. 5 depicts an example process flow for increasing solar power generation during vehicle parking in accordance with one or more embodiments of the disclosure.

FIG. 6 depicts an example process flow for increasing solar power generation during vehicle parking in accordance with one or more embodiments of the disclosure.

FIG. 7 depicts a schematic illustration of an example server architecture for one or more servers that can be used for increasing solar power generation during vehicle parking, in accordance with one or more embodiments of the disclosure.

### DETAILED DESCRIPTION

### Overview

The systems, methods and devices disclosed herein are configured to increase solar power generation during vehicle parking. In particular, a vehicle having advanced driver-assistance systems (ADAS) auto-parking functionality may prioritize a parking space within a given range that may provide substantially increased power generation compared to an adjacent or nearby parking spot. For instance, a vehicle may predict solar power generation per a parking spot taking into account solar irradiance, weather phenomena, solar path (also referred to as a sun path that describes the daily and seasonal arc-like path that the sun appears to follow across the sky as the Earth rotates and orbits the sun), ground inclination, duration of parking event, three-dimensional (3D) environment (e.g. buildings), temperature, state of charge of vehicle battery, power consumption demands of the vehicle while parking, partial and global shading, etc. The vehicle may estimate a parking duration based on prior travel history, a current Global Positioning System (GPS) location associated with a user, and/or attributes of present location given prior knowledge such as map information. For instance, a vehicle may determine one or more parking spots based on perimeter features that may allow the vehicle to park within a threshold of distance (e.g., distances for different parking spots in the same parking lot, different parking lots on the same side of a street without across the street, etc.). The vehicle may estimate a total energy cost to navigate to a particular parking spot and determine a risk profile based on a risk that the parking spot will be unavailable. The vehicle may then navigate autonomously to a parking spot that is capable of improving a solar power generation in a roof mounted solar system on the vehicle. In some embodiments, the vehicle may advise a user in a manual park mode to a parking spot that may be available and may increase solar power generation. For instance, the vehicle may determine a parking spot based at least in part on one or more sensors (e.g., radars or any suitable sensors for detecting the parking spot), and the vehicle may advise the user to drive the vehicle to the parking spot. Sensors may provide better detection than visual detection for remote parking spots.

In some embodiments, a location of a parking spot, inclination of the ground plane of that parking spot, and the orientation of a vehicle in the parking spot may affect shading and sun inclination angle. A vehicle may determine a location of a parking spot and orientations of the vehicle in the parking spot to increase solar power generation. For instance, a vehicle may determine one or more parking locations within a given radius based on several factors, such as a parking location at home, a parking location at a workplace, white list or blacklisted locations defined in a configuration of the vehicle, a distance from a current location to the parking location, map data associated with prior knowledge, parking durations associated with the above parking locations, and/or any combination thereof. For instance, a driver (e.g., named Jeremy Spier) likes shopping for groceries, and may park a vehicle in a parking spot of a grocery store longer than other drivers. The vehicle may record a parking location (e.g., a location of the grocery store, a location of the parking spot, etc.) associated with the grocery store, a parking duration associated with the parking location, and/or any suitable information associated with the grocery store. When the driver parks at a different grocery store, the vehicle may predict a park duration for the driver based on parking history associated with the same type of grocery stores that the driver has visited. The vehicle may determine whether the one or more parking locations are available within line of sight via vehicle sensors such as cameras, radar, LIDAR, other types of sensor, or any combination thereof. In some embodiments, the vehicle may track available and/or unavailable parking locations to determine a better parking location than a current parking location. For instance, the vehicle is parked at a first parking location and the vehicle may track other available and/or unavailable parking locations to determine a second parking location providing better solar irradiance (e.g., no shading, or less shading than the first parking location). Additionally, or alternatively, a remote request may be sent via V2X to determine distance parking spot location availability.

In some embodiments, the vehicle may generate a 3D model of surroundings based on data received from vehicle sensors. The vehicle may estimate a parking duration based on prior travel history of a user and a current GPS location of the vehicle. The vehicle may calculate a solar path, and determine a parking spot inclination angle relative to the solar path. In some embodiments, the vehicle may retrieve data associated with the solar path from a cloud server. In some embodiments, the vehicle may further determine the parking spot inclination angle relative to a solar panel that is conformal to a curved vehicle surface. The vehicle may calculate an added energy generation based on an inclination of the vehicle given a capability to actuate suspension in order to track the sun. The vehicle may calculate shading areas per each parking spot due to fixed structures such as buildings or street signs. In some embodiments, the vehicle may calculate the shading areas based on parameters associated with a solar cell, such as an electrical IV behavior of the cell (e.g., reverse IV curve, also referred to as current-voltage characteristic curve that is a graphical representation of a relationship between a voltage applied across an electrical device (e.g., the cell) and a current flowing through it), a serial/parallel connections of a circuit associated with the solar cell, or any suitable parameters affecting the solar cell. The vehicle may determine an impact of weather data on solar generation (e.g., direct solar radiation vs indirect lighting also referred to as Albedo that may describe a measure of the diffuse reflection of solar radiation out of the total solar radiation). For instance, the vehicle may determine direct and indirect lighting conditions based on weather data (e.g., Haze, clouds, or the like), and a solar radiance flux magnitude. The vehicle may further determine and/or incorporate other environmental parameters, such as temperature and/or wind speeds, that can affect the performance of the solar panel. The vehicle may estimate a total energy gain per each parking spot and a total energy cost per each parking spot to navigate to one or more parking spots. The vehicle may determine whether or not battery capacity and key off systems are capable of storing/utilizing added energy per each parking spot. The vehicle may further calculate the heating of the vehicle under each possible parking spot, which may be desirable or undesirable depending on ambient temperatures, and the corresponding energy cost to modulate the cabin and/or battery temperatures upon vehicle startup. Even if the vehicle is at full state of charge, the vehicle may determine to park in the sun on a cold day to keep the cabin warmer and/or keep the battery at a temperature closer to where we may charge it again instead of having to increase the temperature by using resistive heating of the battery, for example to warm it up.

In some embodiments, the vehicle may estimate a risk profile to avoid missing out on a parking spot repeatedly. For instance, the vehicle may estimate cost per each chance of missing a parking spot based on the parking duration. In some embodiments, the vehicle may estimate cost per each chance of missing a parking spot based on driver behaviors. For instance, the vehicle may determine that a vehicle on a parking spot is leaving, or a vehicle is parking on a parking spot, based on one or more sensor data. The vehicle may determine that an energy generation in a first hour is a higher priority compared to a 5th hour based on a given discount rate associated with the estimated parking duration. The discount rate may refer to a rate that reduces the energy generation. The discount rate may be generated by a method that calculates a valuation of energy generation that values present or near term energy generation more highly than longer term energy generation. The vehicle may estimate a probability of a change in the 3D environment resulting in partial or complete shading, such as a probability of a tall vehicle shading a shorter vehicle after the shorter vehicle has parked in a parking spot.

In some embodiments, the vehicle may determine whether or not the parking spot is available. If the parking spot is available, the vehicle may navigate to the parking spot and park with an orientation (e.g., front or backwards) to avoid shading and to increase solar power generation. If the parking spot is not available, the vehicle may determine a new parking spot. This process may repeat until the vehicle has parked.

In some embodiments, the vehicle may advise a user which parking spots may generate an acceptable amount of solar generation to aid in the user selecting a parking spot.

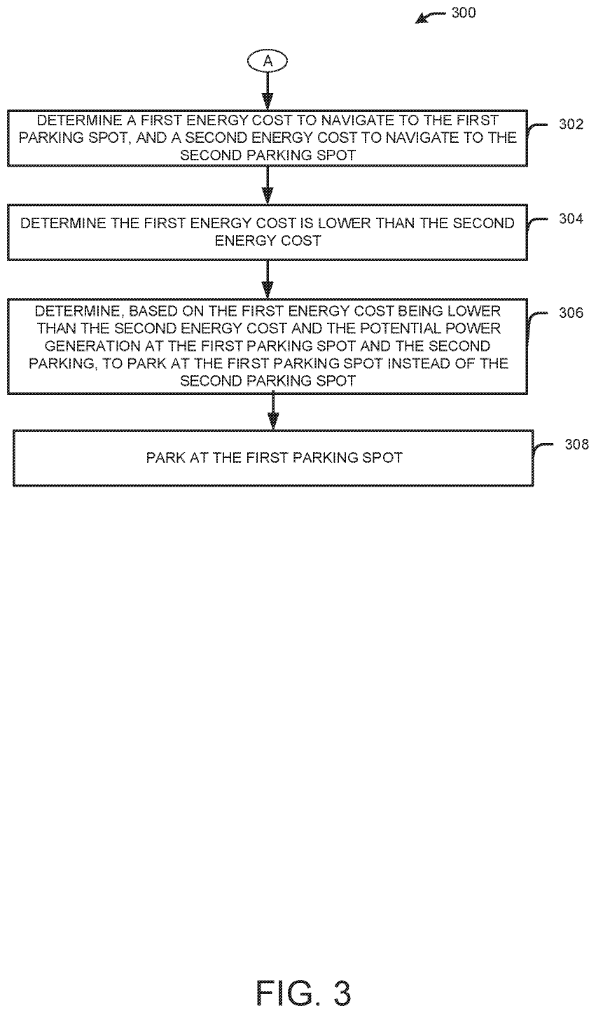

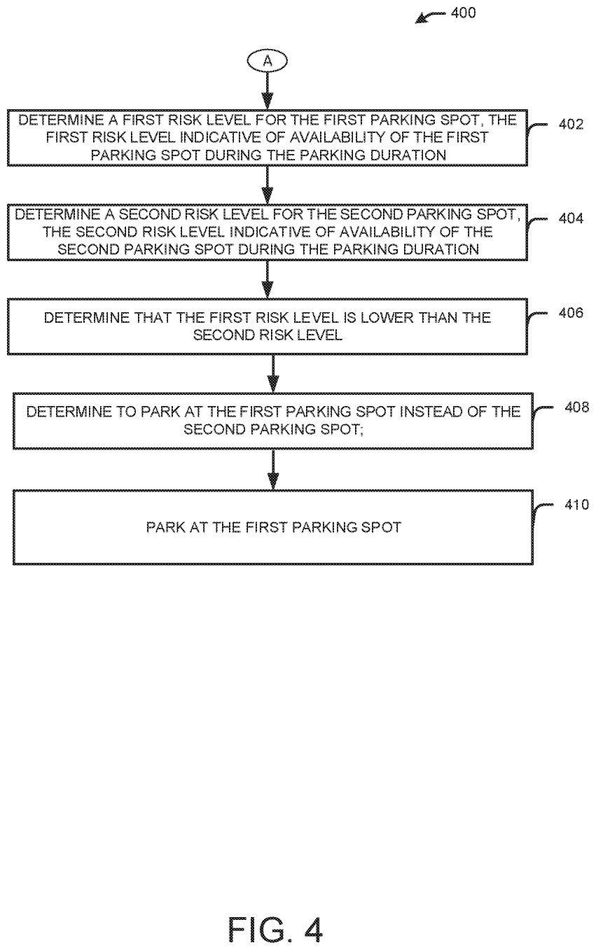

In some embodiments, the vehicle may determine a vehicle path to a determined parking spot (e.g., via a vehicle path planning algorithm that may determine a motion plan and actuate the vehicle). In such way, the vehicle is navigated to the determined parking spot via the vehicle path. In some embodiments, if the determined parking spot is changed, the vehicle may determine an update and/or a modification to the vehicle path (e.g., via an updated/modified vehicle path planning algorithm that may change a motion plan and actuate the vehicle) to a new determined parking spot. Examples are described in FIGS. 3 and 4.

In some embodiments, the prediction of solar irradiance may further be validated by vehicle sensors which may provide an indirect indication of illumination intensity (W/m²), such as cameras and light sensor used to activate headlights. A discrepancy may indicate a shading condition. The vehicle's solar panel degradation or discrete failure events (e.g. hail or someone walking/jumping on a roof of a vehicle cracking all of the solar cells and the vehicle not producing the power we expect based on the inventions calculations) may be also detected and tracked.

In some embodiments, when the battery of the vehicle is full, the vehicle may determine to park in a parking spot having no shading or partial shading to keep the vehicle warmer based on weather and/or temperature of the environment (e.g., on a cold day). In some embodiments, when the battery is full and when there is a probability indicative of extra consumption of power to cool the vehicle due to heat, the vehicle may determine to park in a parking spot having a partial or full shading area to reduce the power consumption.

### Illustrative Embodiments

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

As used herein, a “communication system” can refer to a computer network in which vehicles and roadside units serve as communicating nodes, providing each other with information, such as safety warnings and traffic information. These components can be used in avoiding accidents and in reducing traffic congestion. The components may include dedicated short-range communications (DSRC) devices and/or cellular V2X (C-V2X). DSRC can refer to one-way or two-way short-range to medium-range wireless communication channels specifically designed for automotive use and a corresponding set of protocols and standards.

As used herein, “vehicle-to-everything” (V2X) communication may refer to the communication of information between a vehicle and any entity that may affect the vehicle. It is a vehicular communication system that incorporates other more specific types of communication as V2I (vehicle-to-infrastructure), V2N (vehicle-to-network), V2V (vehicle-to-vehicle), V2P (vehicle-to-pedestrian), V2D (vehicle-to-device) and V2G (vehicle-to-grid). In some aspects, V2X communication technology can include wide local area network (WLAN)-based and cellular-based communications. V2X communication that uses cellular networks can be referred to as “cellular V2X” (or C-V2X) herein to differentiate it from other network-based V2X communication (for example, WLAN-based V2X communication). In some examples, C-V2X can use long-term evolution (LTE) (and its variants) as described, for example, in 3GPP standards Release 14. Moreover, V2X functionalities can support 5G, as described in connection with various standards, such as 3GPP Release 15.

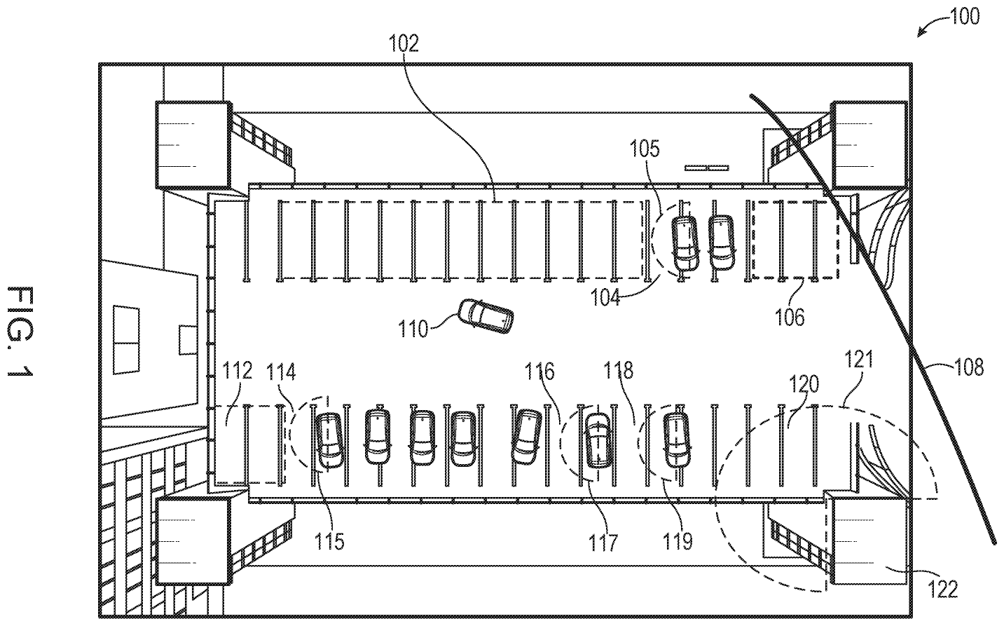

FIG. 1 depicts a diagram of an example implementation 100 for increasing solar power generation during vehicle parking, in accordance with example embodiments of the disclosure. As shown in FIG. 1, a vehicle 110 is in a parking lot. The vehicle 110 may be an autonomous vehicle, or any other suitable vehicle. The vehicle 110 may estimate a parking duration (e.g., from a morning to an afternoon), and determine that parking spots 102-104, 112-120 are available within a line of sight via one or more vehicle sensors (not shown, and/or attributes of those parking spots given prior knowledge such as map information. The vehicle 110 may determine that the parking spots 102 (11 parking spots circled by dash lines) have no shading during the estimated parking duration and a solar path 108, and may determine that the parking spots 104, 114, 116, and 118 may create a partial or complete shading (e.g., a partial shading 105 for the parking spot 104, a partial shading 115 for the parking spot 114, a partial shading 117 for the parking spot 116, and a partial shading 119 for the parking spot 118) based on the solar path 108 and features (e.g., height, length, width, or the like) of the vehicle 110 and features of vehicles parking at adjacent or nearby parking spots. For instance, the vehicle 110 may determine that the vehicle 110 is shorter than vehicle(s) parking at adjacent or nearby parking spots to the parking spots 104, 114, 116, and 118. The vehicle 110 may determine that these vehicles are most likely to create shadings if the vehicle 110 parks at the parking spots 104, 114, 116, and 118. The vehicle 110 may determine that the parking spots 106 (3 parking spots circled by dash lines) and 112 have no shadings. The vehicle 110 may determine a respective distance from the current location of the vehicle 110 to locations associated with the parking spots 102, 106, and 112. The vehicle 110 may determine a respective total energy cost to navigate to the parking spots 102, 106, and 112 based on the respective distance and the solar path 108. The vehicle 110 may determine that the parking spots 106 and 112 are further away from the vehicle 110 compared to the parking spot 102, and determine that navigating to the parking spots 106 and 112 costs greater total energy than navigating to the parking spot 102. In addition, the vehicle 110 may determine that a building 122 may create a complete shading 121 for the parking spot 120 during the solar path 108. Accordingly, the vehicle 110 may determine to park on the parking spot 102 to increase solar power generation.

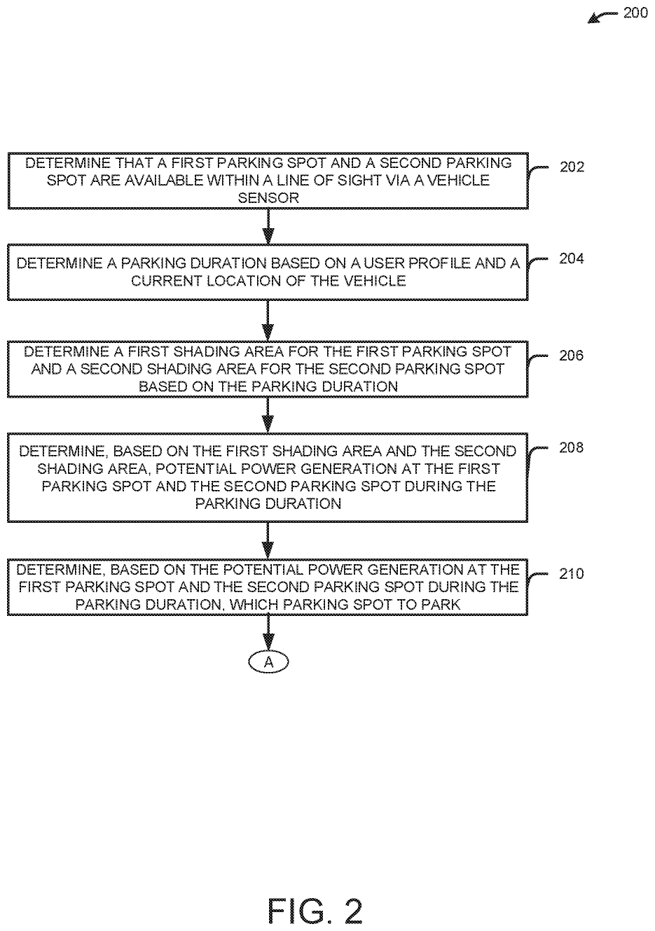

FIG. 2 depicts an example process flow 200 for increasing solar power generation during vehicle parking in accordance with one or more embodiments of the disclosure.

At block 202 of the process flow 200, one or more computer processors of a vehicle may execute computer-executable instructions stored on memory to determine that a first parking spot and a second parking spot are available within a line of sight via a vehicle sensor. Examples of the first parking spot and the second parking spot may be parking spots 102, 104, 106, 112, 114, 116, 118, and 120 in FIG. 1.

At block 204 of the process flow 200, one or more computer processors of a vehicle may execute computer-executable instructions stored on memory to determine a parking duration based on a user profile and a current location of the vehicle. The user profile may include data associated with locations where a user usually goes, data associated with how long the user may stay in each of the above locations (e.g., when the user arrives at a location, and when he user leaves the location), and/or any other suitable information associated with a parking duration.

At block 206 of the process flow 200, one or more computer processors of a vehicle may execute computer-executable instructions stored on memory to determine a first shading area for the first parking spot and a second shading area for the second parking spot based on the parking duration (e.g., a partial shading 105 for the parking spot 104, a partial shading 115 for the parking spot 114, a partial shading 117 for the parking spot 116, a partial shading 119 for the parking spot 118, a complete shading 121 for the parking spot, and no shading for the parking spots 102 and 106). For instance, the one or more computer processors of a vehicle may execute computer-executable instructions stored on memory to calculate a solar path (e.g., the solar path 108 in FIG.1) during the parking duration, determine a shading area for a parking spot based on surrounding environment captured by a vehicle sensor of the vehicle and the solar path.

At block 208 of the process flow 200, one or more computer processors of a vehicle may execute computer-executable instructions stored on memory to determine, based on the first shading area and the second shading area, potential power generation at the first parking spot and the second parking spot during the parking duration. The potential power generation may indicate an electrical power generated by converting energy from sunlight into electricity.

At block 210 of the process flow 200, one or more computer processors of a vehicle may execute computer-executable instructions stored on memory to determine, based on the potential power generation at the first parking spot and the second parking spot during the parking duration, which parking spot to park. For instance, the one or more computer processors of a vehicle may execute computer-executable instructions stored on memory to determine that the potential power generation at the first parking spot is greater than the potential power generation at the second parking spot, and determine to park the vehicle at the first parking spot based on the potential power generation at the first parking spot being greater than the potential power generation at the second parking spot, or vice versa.

FIG. 3 depicts an example process flow 300 for increasing solar power generation during vehicle parking in accordance with one or more embodiments of the disclosure.

At block 302 of the process flow 300, one or more computer processors of a vehicle may execute computer-executable instructions stored on memory to determine a first energy cost to navigate to the first parking spot, and a second energy cost to navigate to the second parking spot. An energy cost may indicate energy consumed by the vehicle for navigating to a parking spot.

At block 304 of the process flow 300, one or more computer processors of a vehicle may execute computer-executable instructions stored on memory to determine the first energy cost is lower than the second energy cost.

At block 306 of the process flow 300, one or more computer processors of a vehicle may execute computer-executable instructions stored on memory to determine, based on the first energy cost being lower than the second energy cost and the potential power generation at the first parking spot and the second parking, to park at the first parking spot instead of the second parking spot.

At block 308 of the process flow 300, one or more computer processors of a vehicle may execute computer-executable instructions stored on memory to park at the first parking spot.

FIG. 4 depicts an example process flow 400 for increasing solar power generation during vehicle parking in accordance with one or more embodiments of the disclosure.

At block 402 of the process flow 400, one or more computer processors of a vehicle may execute computer-executable instructions stored on memory to determine a first risk level for the first parking spot, the first risk level indicative of availability of the first parking spot during the parking duration. For instance, during morning and afternoon as the parking duration, the first parking spot may be available in the morning only, afternoon only, or both. A risk level for the first parking spot available in both morning and afternoon may be lower than a risk level for the first parking spot available in the morning only or afternoon only. In some embodiments, a risk level is determined based on several factors, such as traffic sign recognition capability, vision-based detection of parking spot demarcation, and/or detection of occupancy map of the environment to detect if a given parking spot is fully or partially blocked.

At block 404 of the process flow 400, one or more computer processors of a vehicle may execute computer-executable instructions stored on memory to determine a second risk level for the second parking spot, the second risk level indicative of availability of the second parking spot during the parking duration. For instance, during morning and afternoon as the parking duration, the second parking spot may be available in the morning only, afternoon only, or both. A risk level for the second parking spot available in both morning and afternoon may be lower than a risk level for the second parking spot available in the morning only or afternoon only.

At block 406 of the process flow 400, one or more computer processors of a vehicle may execute computer-executable instructions stored on memory to determine that the first risk level is lower than the second risk level. For instance, the first risk level for the first parking spot available in both morning and afternoon may be lower than the second risk level for the second parking spot available in the morning only or afternoon only.

At block 408 of the process flow 400, one or more computer processors of a vehicle may execute computer-executable instructions stored on memory to determine to park at the first parking spot instead of the second parking spot.

At block 410 of the process flow 400, one or more computer processors of a vehicle may execute computer-executable instructions stored on memory to park at the first parking spot.

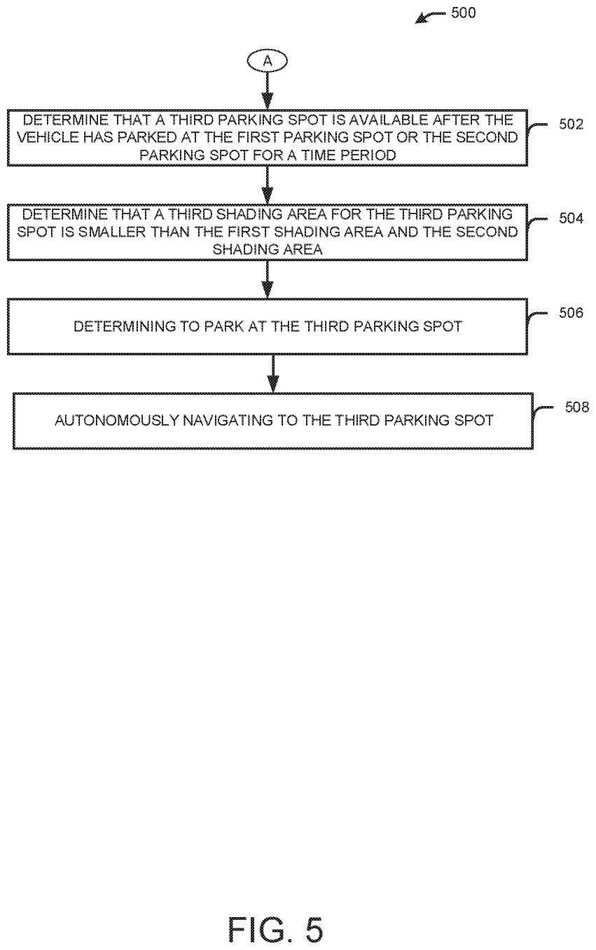

FIG. 5 depicts an example process flow 500 for increasing solar power generation during vehicle parking in accordance with one or more embodiments of the disclosure.

At block 502 of the process flow 500, one or more computer processors of a vehicle may execute computer-executable instructions stored on memory to determine that a third parking spot is available after the vehicle has parked at the first parking spot or the second parking spot for a time period. For instance, the time period may be less than the parking duration. The one or more computer processors of a vehicle may execute computer-executable instructions stored on memory to calculate a solar path during remaining time period of the parking duration, determine the third shading area for the third parking spot based on surrounding environment captured by a vehicle sensor of the vehicle and the solar path.

At block 504 of the process flow 500, one or more computer processors of a vehicle may execute computer-executable instructions stored on memory to determine that a third shading area for the third parking spot is smaller than the first shading area and the second shading area.

At block 506 of the process flow 500, one or more computer processors of a vehicle may execute computer-executable instructions stored on memory to determine to park at the third parking spot.

At block 508 of the process flow 500, one or more computer processors of a vehicle may execute computer-executable instructions stored on memory to autonomously navigate to the third parking spot.

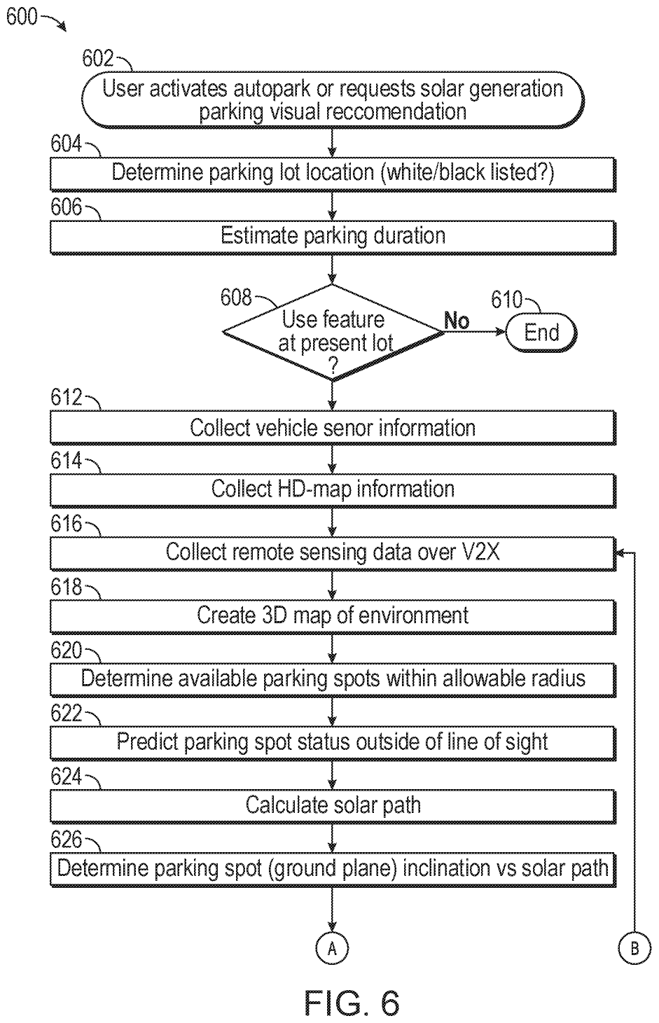

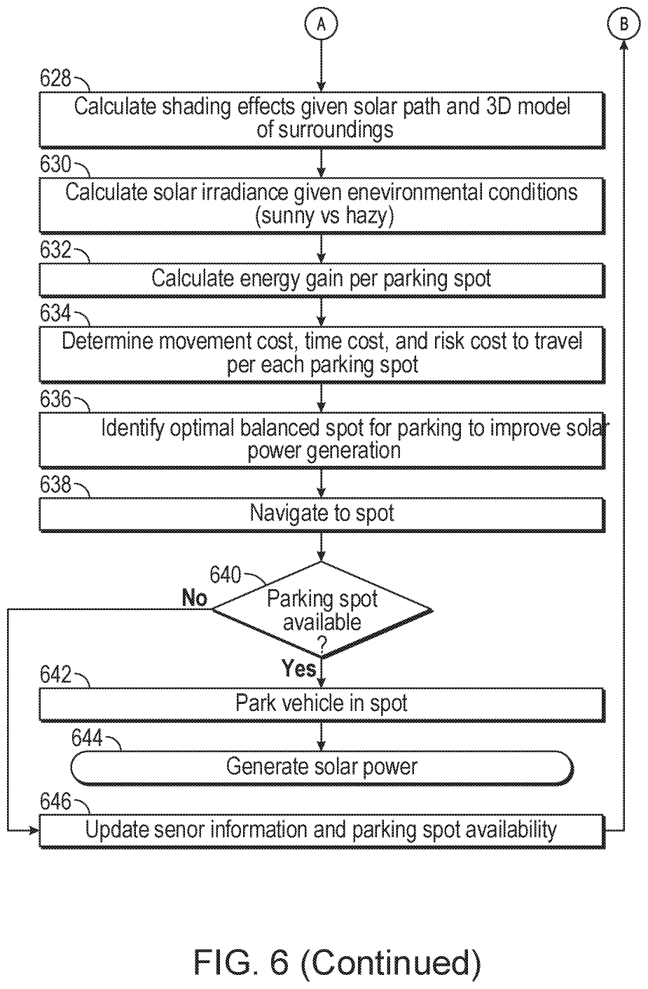

FIG. 6 depicts an example process flow 600 for increasing solar power generation during vehicle parking in accordance with one or more embodiments of the disclosure. Steps 602-646 may be performed by one or more computer processors of a vehicle. For instance, one or more computer processors of a vehicle may execute computer-executable instructions stored on memory to execute computer-executable instructions stored on memory to determine one or more parking spots for improving solar power generation.

At block 602 of the process flow 600, a user may activate auto-park or request a solar generation parking visual recommendation. At block 604, one or more computer processors of a vehicle may determine a parking lot location (e.g., where the vehicle is parked or will be parked). At block 606, the one or more computer processors may estimate a parking duration associated with the vehicle. At block 608, the one or more computer processors may use one or more features at a present lot. If the one more features are not used, the process ends. If the one or more features are used, the process moves to a block 612. At block 612, the one or more computer processors may collect vehicle sensor information. At block 614, the one or more computer processors may collect high definition (HD) map information. At block 616, the one or more computer processors may collect remote sensing data over V2X. At block 618, the one or more computer processors may create a 3D map of environment. At block 620, the one or more computer processors may determine available parking spots within an allowable radius. At block 622, the one or more computer processors may predict a parking spot status outside of line of sight. At block 624, the one or more computer processors may calculate a solar path. At block 626, the one or more computer processors may determine a parking spot (e.g., a ground plane) inclination vs the solar path. At block 628, the one or more computer processors may calculate shading effects given the solar path and the 3D model of surroundings. At block 630, the one or more computer processors may calculate a solar irradiance given environmental conditions (e.g., sunny vs hazy). At block 632, the one or more computer processors may calculate an energy gain per parking spot. At block 634, the one or more computer processors may determine a movement cost, time cost and risk cost to travel per parking spot. At block 636, the one or more computer processors may identify an optimal balanced sport for parking to improve the solar power generation. At block 638, the one or more computer processors may navigate the vehicle to the parking spot. At block 640, the one or more computer processors may determine whether or not the parking spot is available. If yes, the process moves to block 642. At the block 642, the one or more computer processors may park the vehicle in the parking spot. At block 644, the one or more computer processors may generate the solar power. At block 646, the one or more computer processors may update sensor information and parking spot availability. If no, the process may move to the block 646. The one or more computer processors may send the updated sensor information and parking spot availability to the block 616.

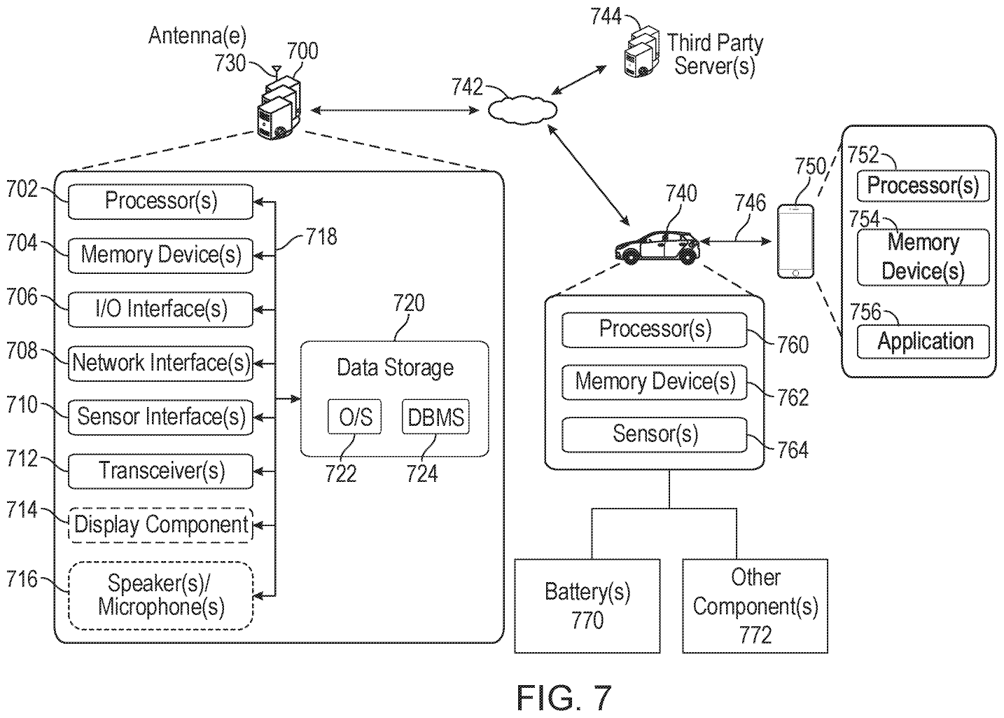

FIG. 7 depicts a schematic illustration of an example server architecture for one or more servers 700 that can be used for increasing solar power generation during vehicle parking, in accordance with one or more embodiments of the disclosure. The server 700 illustrated in the example of FIG. 7 may correspond to a server that may be used by a vehicle (for example, vehicle 110 as shown and described in connection with FIG. 1, above) on a network associated with the vehicle, a delivery vehicle, or a user device. In an embodiment, the server 700 may include a cloud-based server that may serve to store and transmit information (for example, images and video of a user, a user residence, and the like). Some or all of the individual components may be optional and/or different in various embodiments. In some embodiments, at least one of the servers described FIG. 7 may be located at an autonomous vehicle.

The server 700 may be in communication with an AV 740, and one or more user devices 750. The AV 740 may be in communication with the one or more user devices 750. Further, the server 700, the AV 740, and/or the user devices 750 may be configured to communicate via one or more networks 742. The AV 740 may additionally be in wireless communication over one or more network(s) 742 with the user devices 750 via a connection protocol such as Bluetooth or NFC. Such network(s) 742 may include, but are not limited to, any one or more different types of communications networks such as, for example, cable networks, public networks (for example, the Internet), private networks (for example, frame-relay networks), wireless networks, cellular networks, telephone networks (for example, a public switched telephone network), or any other suitable private or public packet-switched or circuit-switched networks. Further, such network(s) may have any suitable communication range associated therewith. In addition, such network(s) may include communication links and associated networking devices (for example, link-layer switches, routers, etc.) for transmitting network traffic over any suitable type of medium including, but not limited to, coaxial cable, twisted-pair wire (for example, twisted-pair copper wire), optical fiber, a HFC medium, a microwave medium, a radio frequency communication medium, a satellite communication medium, or any combination thereof.

In an illustrative configuration, the server 700 may include one or more processors 702, one or more memory devices 704 (also referred to herein as memory 704), one or more input/output (I/O) interface(s) 706, one or more network interface(s) 708, one or more sensor(s) or sensor interface(s) 710, one or more transceiver(s) 712, one or more optional display components 714, one or more optional speakers(s)/camera(s)/microphone(s) 716, and data storage 720. The server 700 may further include one or more bus(es) 718 that functionally couple various components of the server 700. The server 700 may further include one or more antenna(e) 730 that may include, without limitation, a cellular antenna for transmitting or receiving signals to/from a cellular network infrastructure, a GNSS antenna for receiving GNSS signals from a GNSS satellite, a Bluetooth antenna for transmitting or receiving Bluetooth signals, a NFC antenna for transmitting or receiving NFC signals, and so forth. These various components will be described in more detail hereinafter.

The bus(es) 718 may include at least one of a system bus, a memory bus, an address bus, or a message bus, and may permit the exchange of information (for example, data (including computer-executable code), signaling, etc.) between various components of the server 700. The bus(es) 718 may include, without limitation, a memory bus or a memory controller, a peripheral bus, an accelerated graphics port, and so forth. The bus(es) 718 may be associated with any suitable bus architecture.

The memory 704 of the server 700 may include volatile memory (memory that maintains its state when supplied with power) such as RAM and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (for example, FRAM) may enable faster read/write access than certain types of volatile memory.

The data storage 720 may include removable storage and/or non-removable storage including, but not limited to, magnetic storage, optical disk storage, and/or tape storage. The data storage 720 may provide non-volatile storage of computer-executable instructions and other data.

The data storage 720 may store computer-executable code, instructions, or the like that may be loadable into the memory 704 and executable by the processor(s) 702 to cause the processor(s) 702 to perform or initiate various operations. The data storage 720 may additionally store data that may be copied to the memory 704 for use by the processor(s) 702 during the execution of the computer-executable instructions. More specifically, the data storage 720 may store one or more operating systems (O/S) 722; one or more database management systems (DBMS) 724; and one or more program module(s), applications, engines, computer-executable code, scripts, or the like. Some or all of these component(s) may be sub-component(s). Any of the components depicted as being stored in the data storage 720 may include any combination of software, firmware, and/or hardware. The software and/or firmware may include computer-executable code, instructions, or the like that may be loaded into the memory 704 for execution by one or more of the processor(s) 702. Any of the components depicted as being stored in the data storage 720 may support functionality described in reference to corresponding components named earlier in this disclosure.

The processor(s) 702 may be configured to access the memory 704 and execute the computer-executable instructions loaded therein. For example, the processor(s) 702 may be configured to execute the computer-executable instructions of the various program module(s), applications, engines, or the like of the server 700 to cause or facilitate various operations to be performed in accordance with one or more embodiments of the disclosure. The processor(s) 702 may include any suitable processing unit capable of accepting data as input, processing the input data in accordance with stored computer-executable instructions, and generating output data. The processor(s) 702 may include any type of suitable processing unit.

Referring now to other illustrative components depicted as being stored in the data storage 720, the O/S (Operating System) 722 may be loaded from the data storage 720 into the memory 704 and may provide an interface between other application software executing on the server 700 and the hardware resources of the server 700.

The DBMS (Database Management System)724 may be loaded into the memory 704 and may support functionality for accessing, retrieving, storing, and/or manipulating data stored in the memory 704 and/or data stored in the data storage 720. The DBMS 724 may use any of a variety of database models (for example, relational model, object model, graph model, etc.) and may support any of a variety of query languages.

Referring now to other illustrative components of the server 700, the input/output (I/O) interface(s) 706 may facilitate the receipt of input information by the server 700 from one or more I/O devices as well as the output of information from the server 700 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. The I/O interface(s) 706 may also include a connection to one or more of the antenna(e) 730 to connect to one or more networks via a wireless local area network (WLAN) (such as Wi-Fi) radio, Bluetooth, ZigBee, and/or a wireless network radio, such as a radio capable of communication with a wireless communication network, such as a Long Term Evolution (LTE) network, WiMAX network, 3G network, a ZigBee network, etc.

The server 700 may further include one or more network interface(s) 708 via which the server 700 may communicate with any of a variety of other systems, platforms, networks, devices, and so forth. The network interface(s) 708 may enable communication, for example, with one or more wireless routers, one or more host servers, one or more web servers, and the like via one or more networks.

The sensor(s)/sensor interface(s) 710 may include or may be capable of interfacing with any suitable type of sensing device such as, for example, inertial sensors, force sensors, thermal sensors, photocells, and so forth.

The display component(s) 714 may include one or more display layers, such as LED or LCD layers, touch screen layers, protective layers, and/or other layers. The optional camera(s) of the speakers(s)/camera(s)/microphone(s) 716 may be any device configured to capture ambient light or images. The optional microphone(s) of the speakers(s)/camera(s)/microphone(s) 716 may be any device configured to receive analog sound input or voice data. The microphone(s) of the speakers(s)/camera(s)/microphone(s) 716 may include microphones used to capture sound.

It should be appreciated that the program module(s), applications, computer-executable instructions, code, or the like depicted in FIG. 7 as being stored in the data storage 720 are merely illustrative and not exhaustive and that processing described as being supported by any particular module may alternatively be distributed across multiple module(s) or performed by a different module.

It should further be appreciated that the server 700 may include alternate and/or additional hardware, software, or firmware components beyond those described or depicted without departing from the scope of the disclosure.

The user device 750 may include one or more computer processor(s) 752, one or more memory devices 754, and one or more applications, such as a vehicle application 756. Other embodiments may include different components.

The processor(s) 752 may be configured to access the memory 754 and execute the computer-executable instructions loaded therein. For example, the processor(s) 752 may be configured to execute the computer-executable instructions of the various program module(s), applications, engines, or the like of the device to cause or facilitate various operations to be performed in accordance with one or more embodiments of the disclosure. The processor(s) 752 may include any suitable processing unit capable of accepting data as input, processing the input data in accordance with stored computer-executable instructions, and generating output data. The processor(s) 752 may include any type of suitable processing unit.

The memory 754 may include volatile memory (memory that maintains its state when supplied with power). Persistent data storage, as that term is used herein, may include non-volatile memory. In certain example embodiments, volatile memory may enable faster read/write access than non-volatile memory. However, in certain other example embodiments, certain types of non-volatile memory (for example, FRAM) may enable faster read/write access than certain types of volatile memory.

Referring now to functionality supported by the user device 750, the AV application 756 may be a mobile application executable by the processor 752 that can be used to present options and/or receive user inputs of information related to the disclosed embodiments. In addition, the user device 750 may communicate with the AV 740 via the network 742 and/or a direct connection, which may be a wireless or wired connection. The AV 740 may additionally be in wireless communication 746 with the user device 750 via a connection protocol such as Bluetooth or Near Field Communication. The user device 750 may include a camera, scanner, bio reader or the like to capture biometric data of a user, perform certain processing step on the biometric date, such as extracting features from captures biometric data, and then communicate those extracted features to one or more remote servers, such as one or more of cloud-based servers.

The AV 740 may include one or more computer processor(s) 760, one or more memory devices 762, one or more sensors 764, one or more batteries 770, one or more other components 772 (e.g., electrical panel(s), alternator(s), engine(s), int./ext. lighting, climate control(s), human machine interface(s), etc.) and one or more applications, such as an autonomous driving application 756. Other embodiments may include different components.

The processor(s) 760 may be configured to access the memory 762 and execute the computer-executable instructions loaded therein. For example, the processor(s) 760 may be configured to execute the computer-executable instructions of the various program module(s), applications, engines, or the like of the device to cause or facilitate various operations to be performed in accordance with one or more embodiments of the disclosure. The processor(s) 760 may include any suitable processing unit capable of accepting data as input, processing the input data in accordance with stored computer-executable instructions, and generating output data. The processor(s) 760 may include any type of suitable processing unit.

The memory 762 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory

The battery(s) 770 can comprise a single or dual, 12/24 volt battery that is/are charged by other components 772 (e.g., alternators) of the vehicle 740. In various embodiments, the battery(s) 770 may be utilized to power functions of the vehicle 740 such as other components 772. The battery(s) can be controlled by the processor 760.

It should be appreciated that the program module(s), applications, computer-executable instructions, code, or the like depicted in FIG. 7 as being stored in the data storage 720 are merely illustrative and not exhaustive and that processing described as being supported by any particular module may alternatively be distributed across multiple module(s) or performed by a different module.

It should further be appreciated that the server 700 may include alternate and/or additional hardware, software, or firmware components beyond those described or depicted without departing from the scope of the disclosure.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

A software component may be stored as a file or other data storage construct. Software components of a similar type or functionally related may be stored together such as, for example, in a particular directory, folder, or library. Software components may be static (for example, pre-established or fixed) or dynamic (for example, created or modified at the time of execution).

Software components may invoke or be invoked by other software components through any of a wide variety of mechanisms. Invoked or invoking software components may comprise other custom-developed application software, operating system functionality (for example, device drivers, data storage (for example, file management) routines, other common routines and services, etc.), or third-party software components (for example, middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A method for parking a vehicle, comprising:
determining that a first parking spot and a second parking spot are available within a line of sight via a vehicle sensor;
determining a parking duration based on a user profile and a current location of the vehicle;
determining a first shading area for the first parking spot and a second shading area for the second parking spot based on the parking duration;
determining, based on the first shading area and the second shading area, potential power generation at the first parking spot and the second parking spot during the parking duration; and
determining, based on the potential power generation at the first parking spot and the second parking spot during the parking duration, in which parking spot to park.

2. The method of claim 1, further comprising:
determining a first energy cost to navigate to the first parking spot, and a second energy cost to navigate to the second parking spot;
determining the first energy cost is lower than the second energy cost;
determining, based on the first energy cost being lower than the second energy cost and the potential power generation at the first parking spot and the second parking, to park at the first parking spot instead of the second parking spot; and
parking the vehicle at the first parking spot.

3. The method of claim 1, further comprising:
determining a first risk level for the first parking spot, the first risk level indicative of availability of the first parking spot during the parking duration;
determining a second risk level for the second parking spot, the second risk level indicative of availability of the second parking spot during the parking duration;
determining that the first risk level is lower than the second risk level;
determining to park at the first parking spot instead of the second parking spot; and
parking the vehicle at the first parking spot.

4. The method of claim 1, further comprising:
determining that a third parking spot is available after the vehicle has parked at the first parking spot or the second parking spot for a time period;
determining that a third shading area for the third parking spot is smaller than the first shading area and the second shading area;
determining to park at the third parking spot; and
autonomously navigating the vehicle to the third parking spot.

5. The method of claim 1, wherein determining the first shading area for the first parking spot and the second shading area for the second parking spot based on the parking duration comprises:
generating a 3D model of surroundings of the vehicle based on the parking duration, wherein the 3D model is indicative of a change in a solar path during the parking duration; and
determining the first shading area and the second shading area based on the 3D model.

6. The method of claim 1, further comprising:
determining to park at the first parking spot with a first orientation of the vehicle for a first time period based on the parking duration and the first shading area;
parking at the first parking spot with the first orientation;
determining to park at the first parking spot with a second orientation of the vehicle for a second time period based on the parking duration and the first shading area; and
parking the vehicle at the first parking spot with the second orientation.

7. The method of claim 1, further comprising receiving a user input indicative of parking at the first parking spot or the second parking spot.

8. A vehicle comprising:
at least one memory comprising computer-executable instructions; and
one or more computing processors configured to access the at least one memory and execute the computer-executable instructions to:
determine that a first parking spot and a second parking spot are available within a line of sight via a vehicle sensor;
determine a parking duration based on a user profile and a current location of the vehicle;
determine a first shading area for the first parking spot and a second shading area for the second parking spot based on the parking duration;
determine, based on the first shading area and the second shading area, potential power generation at the first parking spot and the second parking spot during the parking duration; and
determine, based on the potential power generation at the first parking spot and the second parking spot during the parking duration, in which parking spot to park.

9. The vehicle of claim 8, wherein the one or more computing processors is further configured to access the at least one memory and execute the computer-executable instructions to:
determine a first energy cost to navigate to the first parking spot, and a second energy cost to navigate to the second parking spot;
determine the first energy cost is lower than the second energy cost;
determine, based on the first energy cost being lower than the second energy cost and the potential power generation at the first parking spot and the second parking, to park at the first parking spot instead of the second parking spot; and
park at the first parking spot.

10. The vehicle of claim 8, wherein the one or more computing processors is further configured to access the at least one memory and execute the computer-executable instructions to:
determine a first risk level for the first parking spot, the first risk level indicative of availability of the first parking spot during the parking duration;
determine a second risk level for the second parking spot, the second risk level indicative of availability of the second parking spot during the parking duration;
determine that the first risk level is lower than the second risk level;
determine to park at the first parking spot instead of the second parking spot; and
park at the first parking spot.

11. The vehicle of claim 8, wherein the one or more computing processors is further configured to access the at least one memory and execute the computer-executable instructions to:
determine that a third parking spot is available after the vehicle has parked at the first parking spot or the second parking spot for a time period;
determine that a third shading area for the third parking spot is smaller than the first shading area and the second shading area;
determine to park at the third parking spot; and
autonomously navigate to the third parking spot.

12. The vehicle of claim 8, wherein determining the first shading area for the first parking spot and the second shading area for the second parking spot based on the parking duration comprises:
generating a 3D model of surroundings of the vehicle based on the parking duration, wherein the 3D model is indicative of a change in a solar path during the parking duration; and
determining the first shading area and the second shading area based on the 3D model.

13. The vehicle of claim 8, wherein the one or more computing processors is further configured to access the at least one memory and execute the computer-executable instructions to:
determine to park at the first parking spot with a first orientation of the vehicle for a first time period based on the parking duration and the first shading area;
park at the first parking spot with the first orientation;
determine to park at the first parking spot with a second orientation of the vehicle for a second time period based on the parking duration and the first shading area; and
park at the first parking spot with the second orientation.

14. A system for parking a vehicle, comprising:
at least one memory device that stores computer-executable instructions; and
at least one processor configured to access the at least one memory device, wherein the processor is configured to execute the computer-executable instructions to:
determine that a first parking spot and a second parking spot are available within a line of sight via a vehicle sensor;
determine a parking duration based on a user profile and a current location of the vehicle;
determine a first shading area for the first parking spot and a second shading area for the second parking spot based on the parking duration;
determine, based on the first shading area and the second shading area, potential power generation at the first parking spot and the second parking spot during the parking duration; and
determine, based on the potential power generation at the first parking spot and the second parking spot during the parking duration, in which parking spot to park the vehicle.

15. The system of claim 14, wherein the processor is further configured to execute the computer-executable instructions to:
determine a first energy cost to navigate to the first parking spot, and a second energy cost to navigate to the second parking spot;
determine the first energy cost is lower than the second energy cost;
determine, based on the first energy cost being lower than the second energy cost and the potential power generation at the first parking spot and the second parking, to park at the first parking spot instead of the second parking spot; and
park the vehicle at the first parking spot.

16. The system of claim 14, wherein the processor is further configured to execute the computer-executable instructions to:
determine a first risk level for the first parking spot, the first risk level indicative of availability of the first parking spot during the parking duration;
determine a second risk level for the second parking spot, the second risk level indicative of availability of the second parking spot during the parking duration;
determine that the first risk level is lower than the second risk level;
determine to park at the first parking spot instead of the second parking spot; and
park the vehicle at the first parking spot.

17. The system of claim 14, wherein the processor is further configured to execute the computer-executable instructions to:
determine that a third parking spot is available after the vehicle has parked at the first parking spot or the second parking spot for a time period;
determine that a third shading area for the third parking spot is smaller than the first shading area and the second shading area;
determine to park at the third parking spot; and
autonomously navigate the vehicle to the third parking spot.

18. The system of claim 14, wherein determining the first shading area for the first parking spot and the second shading area for the second parking spot based on the parking duration comprises:
generating a 3D model of surroundings of the vehicle based on the parking duration, wherein the 3D model is indicative of a change in a solar path during the parking duration; and
determining the first shading area and the second shading area based on the 3D model.

19. The system of claim 14, wherein the processor is further configured to execute the computer-executable instructions to:
determine to park at the first parking spot with a first orientation of the vehicle for a first time period based on the parking duration and the first shading area;
park at the first parking spot with the first orientation;
determine to park at the first parking spot with a second orientation of the vehicle for a second time period based on the parking duration and the first shading area; and
park the vehicle at the first parking spot with the second orientation.

20. The system of claim 14, wherein the processor is further configured to execute the computer-executable instructions to: receive a user input indicative of parking at the first parking spot or the second parking spot.
